(19) United States
(12) Patent Application Publication
(10) Pub. No.: US 2020/0307458 A1
(43) Pub. Date: Oct. 1, 2020

(54) SELECTIVE DISPLAY WINDOW FOR VEHICLE

(71) Applicant: GENTEX CORPORATION, Zeeland, MI (US)

(72) Inventor: Matthew W. Chiodo, Farmington Hills, MI (US)

(73) Assignee: GENTEX CORPORATION, ZEELAND, MI (US)

(21) Appl. No.: 16/830,714

(22) Filed: Mar. 26, 2020

Related U.S. Application Data
(60) Provisional application No. 62/824,366, filed on Mar. 27, 2019.

(51) Int. Cl. B60R 1/12; H04N 5/232

(52) U.S. Cl. CPC B60R 1/12; B60R 2001/1253; H04N 5/23203

(57) ABSTRACT

A window display system may comprise a window having a display element; a display device capable of displaying images; and an image source in communication with the display device; and the display device may be configured to cause images to be displayed on the display element. The image source may comprise a controller. The window may be in a vehicle and may be one of a rear and a side vehicle window. The vehicle may have a full display mirror assembly; and the full display mirror assembly may be in communication with and configured to provide inputs to the image source.

### CROSS REFERENCE TO RELATED APPLICATIONS

This application claims the benefit of and priority to U.S. Provisional Patent Application No. 62/824,366, filed on Mar. 27, 2019, entitled Selective Display Window for Vehicle, the entire disclosure of which is hereby incorporated herein by reference.

### FIELD OF THE DISCLOSURE

This disclosure relates generally to a window display system that allows the selective display of images on a vehicle window, and in particular, to a window display system that allows the display of images on a vehicle window when the vehicle's rearview display assembly is operating in a display mode.

### BACKGROUND

In a vehicle having a full display mirror assembly, the full display mirror assembly may have a mirror mode and a display mode. In mirror mode, the full display mirror assembly may function as a rearview mirror, and a mirror element may reflect an image to a user. The image may be acquired, at least in part, through the vehicle rearview window, and may be of a scene of the view to the rear of the vehicle.

In display mode, the full display mirror assembly may utilize an imager to capture video images of a scene to the rear of the vehicle. The captured images may be displayed on a display element of the full display mirror assembly in real time. When the full display mirror assembly is operating in display mode, the mirror element is not in use.

A toggle switch or other control mechanism may allow a user to switch between the mirror mode and the display mode.

### SUMMARY

According to some aspects, a window display system may comprise a window having a display element; a full display mirror assembly; a display device capable of causing images to be displayed on the display element and in communication with the full display mirror assembly; and an image source in communication with the display device. The full display mirror assembly may be configured to provide inputs to at least one of the image source, the display device, and the display element. The window display system may be configured to cause images to be displayed on the display element upon receiving a first particular input from the full display mirror assembly. The image source may comprise a controller. The window may be in a vehicle and may be one of a rear and a side vehicle window. The vehicle may have a full display mirror assembly; and the full display mirror assembly may be in communication with and configured to provide inputs to the image source. The image source may be configured to activate the window display system upon receiving a first particular input from the full display mirror assembly. The image source may be configured to deactivate the window display system upon receiving a second particular input from the full display mirror assembly. The image source may comprise one of a mobile telephone, a tablet computer, and a portable computer. The image source may be linked to a global positioning system; and the image source may be configured to select at least one image from a plurality of stored images based on the location of the vehicle.

The window display system may further comprise a shroud; and the shroud may be disposed to at least partially cover the display device. The display element may be at least partially reflective and at least partially transmissive. The display element may comprise a first partially reflective, partially transmissive substrate defining a first surface and a second surface; a second partially reflective, partially transmissive substrate defining a third surface and a fourth surface; a transflective coating positioned on at least one of the first and second surfaces of the first substrate; an antireflective electrode positioned on at least one of the third and fourth surfaces; and an electro-optic medium positioned in a cavity between the second surface of the first substrate and the third surface of the second substrate; wherein the first substrate and the second substrate may be configured to be held in a parallel spaced apart relationship and sealed around a perimeter of the first and second substrates; and wherein the electro-optic assembly may be configured to cause the display of an image from a display device, thereby displaying the image on the window display system of the vehicle.

According to some aspects, a window display system may comprise a window having a display element; and an image source comprising a processor; and the image source may be configured to cause the display of selected images on the display element upon the receipt by the window display system of a first particular input from a full display mirror, the full display mirror being in communication with the image source. The display element may comprise a liquid crystal display. The window may be in a vehicle and may be one of a rear and a side vehicle window; the vehicle may have a full display mirror assembly; and the full display mirror assembly may be in communication with and configured to provide inputs to the image source. The image source may be configured to activate the window display system or to cause images to be displayed on a display element of the window display system upon receiving a first particular input from the full display mirror assembly. The image source may be configured to deactivate the window display system or to cause the display of images on the display element to be stopped upon receiving a second particular input from the full display mirror assembly.

According to some aspects, a display system may comprise a window having a display element; an image source comprising a processor; a full display mirror assembly; wherein the full display mirror assembly may be configured to provide inputs to the image source; and wherein the image source may be configured to provide images to display element for display upon receipt of a first particular input from the full display mirror assembly. The window may be a vehicle window. The display element may be at least partially transmissive and at least partially reflective. The processor may be configured to cause the display element to stop displaying images upon the receipt of a second particular input from the full display mirror assembly; and the second particular input may indicate that the full display mirror assembly is in a mirror mode

### BRIEF DESCRIPTION OF THE DRAWINGS

FIG. 1 illustrates a perspective view of a first embodiment of the window display system disposed in a vehicle in accordance with the present disclosure;

FIG. 2 illustrates a cross-sectional schematic representation of a first embodiment of a window surface having a display element in accordance with the present disclosure;

FIG. 3 illustrates a schematic representation of a first embodiment of the window display system in accordance with the present disclosure;

FIG. 4 illustrates a perspective view of a second embodiment of the window display system disposed in a vehicle in accordance with the present disclosure;

FIG. 5 illustrates a cross-sectional schematic representation of a second embodiment of a window surface having a display element in accordance with the present disclosure; and

FIG. 6 illustrates a schematic representation of a second embodiment of the window display system in accordance with the present disclosure.

### DETAILED DESCRIPTION

A window display system to selectively display content on vehicle windows may be utilized in a vehicle, and in particular, in at least one of a rear window and a side window of the vehicle. The window display system may be operable to activate automatically when a driver may not need to use the window, such as when the driver is using a full display mirror assembly in the display mode.

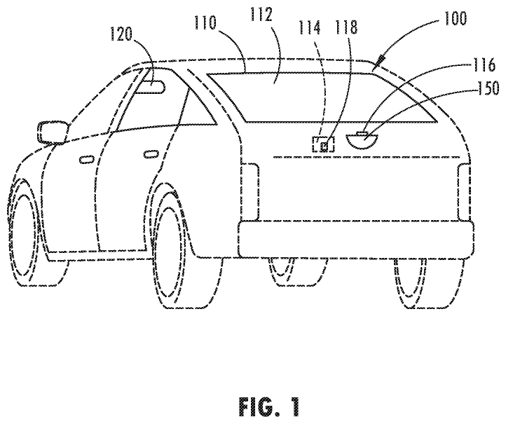

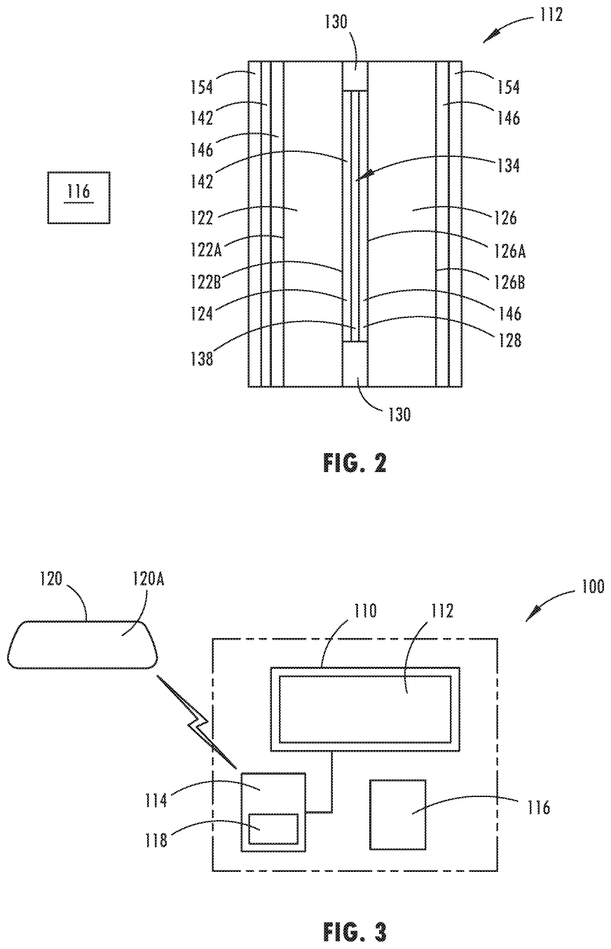

Referring to FIGS. 1-3, an embodiment of a window display system is shown generally at 100. Window display system 100 may comprise a window 110 having a display element 112, and an image source 114. In some embodiments, window display system 100 may further comprise a display device 116 such as a projector or a liquid crystal display configured to cause images to be displayed on display element 112. In some embodiments, display element 112 may comprise, for example, a liquid crystal display (LCD), a light emitting diode (LED), or an organic light emitting diode (OLED). Display element 112 may be configured to, upon the receipt of a first particular input from display device 116, display images.

Window display system 100 may further comprise a full display mirror assembly 120. Image source 114 may be configured to be in communication with full display mirror assembly 120. As used herein, a “full display mirror assembly” is a structure that may selectively provide a reflected view and selectively provide an image of a scene to the rear of a driver, the scene to be displayed on a display surface 120A of full display mirror assembly 120. The reflected view and the image of the scene may not be displayed at the same time, but one at a time.

Full display mirror assembly 120 may be operable to change operating states of display surface 120A from a display state to a transparent state. In the display state, display element may be configured to project image data outward toward a viewer (display mode). In the transparent state, display surface 120A may be substantially transparent allowing a reflective surface disposed between display surface 120A and a rear housing (not shown) to function as a mirror (mirror mode).

In some embodiments, full display mirror assembly 120 may be configured to function as a rearview display for the vehicle. In the display mode, image data may be displayed on display surface 120A of display element 120. The image data may be captured by one or more imagers in communication with full display mirror assembly 120. The one or more imagers may be configured to capture image data of various fields of view or various views of scenes proximate the vehicle. In this way, full display mirror assembly 120 may selectively display the image data or a reflected scene.

A display module (not shown) of full display mirror assembly 120 may be capable of causing an image as captured by a rearward facing camera or other imaging system to be displayed on display surface 120A. Full display mirror assembly 120 may further include a reflective surface for selectively reflecting a scene. Full display mirror assembly 120 may be configured to selectively display either the captured image or the reflected view of the scene on display surface 120A. Full display mirror assembly 120 may be configured with a user operating mechanism (not shown) such as a switch, a lever, or a button, that allows a user to determine whether the captured image or the reflected view of the scene is displayed on full display mirror assembly 120.

Full display mirror assembly 120 may further comprise an electro-optic surface configured to selectively darken images reflected by the reflective surface.

In some embodiments, full display mirror assembly 120 may be designed for mounting directly to a vehicle windshield. Additionally or alternatively, full display mirror assembly 120 may be designed for mounting to a ceiling of the vehicle.

Display device 116 may be configured to cause an image, either a still image or a video image, to be displayed on display element 112. In some embodiments, display device 116 may be configured to generate images to be displayed on display element 112. In some embodiments, display element 112 may be configured to reflect images generated by display device 116. In some embodiments, display device 116 may be positioned to project or display images onto display element 112. Display device 116 may be substantially transparent depending on an operating configuration controlled by the controller.

Display device 116 may be secured to and/or mounted on a portion of the vehicle. For example, display device 116 may be positioned in a rear spoiler, in the roof liner, in a rearview assembly, in a vehicle headliner, on a rear shelf, or any other suitable location within or on the exterior of the vehicle. Display device 116 may be disposed on top of the surface to which it is mounted, at a predetermined position above the vehicle surface, recessed within the surface, or disposed below the top surface of the vehicle part in which it is mounted. In some embodiments, display device 116 may be recessed within a surface and may be configured to move between a deployed and a non-deployed position. A shroud 150 may at least partially cover display device 116 to protect it from the elements and from impacts, and for aesthetic reasons.

Window 110 may be a vehicle window, and may be at least one of a rear window and a side window in a vehicle. Window 110 may have an interior surface configured to face an interior of the vehicle and an exterior surface configured to face away from the interior of the vehicle.

Display element 112 may be disposed on one of interior surface and exterior surface or may be within window 110 between interior surface and exterior surface. Display element 112 may extend over the entire window 110 or may extend over only a portion of the window 110. Display element 112 may comprise a surface configured to be transparent when images are not being displayed on display element 112. In some embodiments, display element 112 may comprise a surface configured to reflect images from display device 116. In some embodiments, display element 112 may comprise a surface configured to generate images upon receipt of appropriate image data.

Display element 112 may be selectively transparent and selectively reflective or opaque. In some embodiments, display element 112 of window 110 may be a film or a coating applied to one of interior surface 110A and exterior surface 110B of window 110. In some embodiments, display element 112 may comprise an electro-optic element 121. Electro-optic element 121 may comprise a first partially reflective, partially transmissive substrate 122 and a second partially reflective, partially transmissive substrate 126. First partially reflective, partially transmissive substrate 122 may have a first surface 122A and a second surface 122B. One or more layers of electrically conductive material 124 may be associated with second surface 122B of first substrate 122. The one or more layers of electrically conductive material 124 may serve as an electrode for electro-optic element 121. Second partially reflective, partially transmissive substrate 126 may have a third surface 126A and a fourth surface 126B. One or more layers of electrically conductive material 128 may be associated with third surface 126A of second substrate 126, and serve as an electrode for electro-optic element 121. First and second substrates 122, 126 may be positioned in a parallel spaced-apart relationship. A sealing member 130 may extend substantially around a perimeter of first and second substrates 122, 126. Sealing member 130 may operatively bond the one or more layers of electrically conductive material 124, 128 to second surface 122B of first substrate 122 and third surface 126A of second substrate 126 respectively. A cavity 134 may be defined by second surface 122B of first substrate 122, third surface 126A of second substrate 126, and sealing member 130. An electro-optic medium 138 may be disposed in cavity 134 between first and second substrates 122, 126. A power source (not shown) may be disposed to provide power to electro-optic element 121 to control light transmittance through window 110. Electro-optic medium 138 may be operable to, upon activation, darken, thereby reducing the light transition through electro-optic element 121.

In some embodiments, at least one of substrates 122, 126 may be glass, and the glass may be tempered glass. In some embodiments, both substrates 122, 126 may be tempered glass. In some embodiments, window 110 with electro-optic element 121 may serve as both a vehicle window and as display element 112.

In some embodiments, glass may be laminated, and display element 112 may be disposed on a surface of laminated glass window 110. Display element 112 may be disposed on either the interior or the exterior surface of window 110.

In some embodiments, a transflective coating 142 may be disposed on at least one of first and second surfaces 122A, 122B of first substrate 122 and third surface 126A of second substrate 126. As shown, transflective coating 142 is positioned proximate first surface 122A of first substrate 122, but may additionally or alternatively be positioned on second surface 122B or third surface 126A without departing from the teachings provided herein. In some embodiments, an antireflective coating 146 may be positioned on at least one of first and second surface 122A, 122B of first substrate 122, and third and fourth surfaces 126A, 126B of second substrate 126. As shown, antireflective coating 146 is positioned proximate first surface 126A of second substrate 126, but may additionally or alternatively be positioned on second surface 122B of first substrate 122 or fourth surface 126B of second substrate 126. It will be understood that, although described as separate layers, at least one of transflective coating 142 and antireflective coating 146 may share properties which function as other coatings. For example, in some embodiments, transflective coating 142 may comprise a thin metal layer or metal-based coating and be disposed on at least one of second surface 122V of first substrate 122 and third surface 126A of second substrate 126; and may also function as an electrode. In some embodiments, antireflective coatings 146 may comprise a thin metal layer or metal-based coating and be disposed on third surface 126A of second substrate 126, and may serve a dual purpose, also functioning as an electrode.

In some embodiments, transflective coating 142 may be positioned on one of second surfaces 122B of first substrate 122 and third surface 126A of second substrate 126, and antireflective coating 146 may be positioned on whichever of second and third surfaces 122B, 126A transflective coating 142 is not positioned.

Display element 112 may be operable to have a varying light transmittance. A “transparent” or “clear state” of display element 112 refers to the condition of maximum light transmittance. The activation of electro-optic medium 138 may reduce the transmittance of display element 112 to a darkened state or a state of low transmittance. A controller 118 may be configured to receive inputs from full display mirror assembly 120 and may increase or decrease light transmission through electro-optic element 121 of display element 112 based on the received inputs. For example, when full display mirror assembly 120 is in mirror mode, images may not be displayed on display element 112. Controller 118 may receive inputs corresponding to the state of full display mirror assembly 120, and may provide inputs to electro-optic element 121 to operate in a transparent state, with most incident light passing through display element 112. Conversely, when full display mirror assembly 120 is operating in display mode, images may be displayed on display element 112. Controller 118 may receive inputs indicating the status of display element 112, and light transmission through display element 112 may be reduced to enhance visibility of the displayed images.

Display element 112 may be selectively reflective. Much of the reflectance of display element 112 may come from transflective coating 142 located on either first or second surface 122A, 122B of first substrate 122 or third surface 126A of second substrate 126. Light may be transmitted through transflective coating 142 when electro-optic medium 138 is not activated. However, when electro-optic medium 138 is activated and there is little or no light transmission through display element 112, transflective coating 142 may reflect incident light, including any images displayed on display element 112 from display device 116.

In some embodiments, image source 114 may be in communication with controller 118. Controller 118 may be operable to at least activate window display system 100. Controller 118 may be in electrical communication with full display mirror assembly 120 and may receive inputs from full display mirror assembly 120. Image source 114 may be configured to generate images to be displayed on display element 112. Image source may generate the images upon the receipt of a first particular input. The first particular input may comprise an input indicating that full display mirror assembly 120 is in a display mode displaying images captured by the rearward facing camera. In some embodiments, an additional input may be required to cause images to be displayed on display element 112. Additional inputs may include, for example, a user input.

Controller 118 may be operable to cause images to be displayed on display element 112. In some embodiments, controller 118 may be configured to cause images to be displayed on display element 112 upon receipt of a first particular input. Controller 118 may further be configured to deactivate window display system 100 upon receipt of a second particular input. The second particular input may indicate, for example, that full display mirror assembly 120 is operating in mirror mode. In some embodiments, controller 118 may be configured to activate window display system 100 when the vehicle transmission is placed in a parked condition. Controller 118 may also be configured to select images to be displayed on window display system 100. Thus, controller may be configured to synchronize the display of images with the state of full display mirror assembly 120, with images being displayed when full display mirror assembly 120 is in a display mode and with no images being displayed when full display mirror assembly 120 is in mirror mode.

In some embodiments, image source 114 may be in communication with display device 116. As shown, image source 114 is disposed in proximity to display device 116, but image source 114 may be elsewhere in or on vehicle. For example, image source 114 may be disposed in rearview assembly, in an infotainment console, under a rear shelf, or in any other suitable location.

In some embodiments, image source 114 may comprise at least one stored still or video image. In some embodiments, image source 114 may store a plurality of video images. Upon receipt of the first particular input, image source 114 may select a video for display and transmit the selected video to display device 116 for display on display element 112.

In some embodiments, image source 114 may comprise a mobile telephone, a tablet, computer, or other device, or may be in communication with a mobile telephone, a tablet, computer, or other device, and may be capable of accessing the internet. Image source 114 may be operable to access an application or a program stored either on a device or remotely. The application or program may comprise at least one video image. Upon receipt of the first particular input, image source 114 may access the program or application, select a video for display, and transmit the selected video to display device 116 for display on display element 112.

In some embodiments, image source 114 may have global positioning system (GPS) capabilities or be in communication with a GPS-enabled device. Image source 114 may select at least one image to display based on the location of the vehicle or based on inputs from the GPS-enabled device. For example, if the vehicle is approaching a particular restaurant, image source 114 may select and display an image advertising the restaurant. Additionally or alternatively, image source 114 may select images for display randomly, or may display images in a preset order or rotation. The selected images may be chosen based on inputs received from the GPS-enabled device. For example, the images may be of several stores, restaurants, gas stations, or similar establishments in the vicinity of the vehicle. Alternatively, some images may be of establishments in the vicinity of the vehicle and some may be unrelated to the location of the vehicle. In some embodiments, some images may be chosen based on a destination entered into the GPS-enabled device, and may include establishments along the route to the destination. The images may include advertising, location of the establishment, hours of the establishment, and other information.

In some embodiments, to activate window display system 100, upon receiving a first particular input, such as, for example, an input indicating that full display mirror assembly 120 is operating in display mode, image source 114 may select image data for an image or images to display and transmit the selected image data to display device 116. Display device 116 may cause the image or images corresponding to the selected image data to be displayed on display element 112. In some embodiments, electro-optic element 121 of display element 112 may be activated, thereby reducing light transmission through window 110 to allow better visibility of the image.

If full display mirror assembly 120 is returned to mirror mode, image source 114 may receive a second particular input such as, for example, an input indicating that full display mirror assembly 120 is operating in mirror mode. Upon the receipt of the second particular input, display device 116 may cause the displaying of images onto display element 112 to stop, and window 110 may return to a clear state with maximum light transmission.

In some embodiments, image source 114 may have or be in communication with a user interface (not shown). A user may select images to be displayed on image display system 100 through the user interface. In some embodiments, user interface may also be used to cause or stop the display of images on display element when images captured by a rearward facing camera are displayed on the electronic display of full display mirror assembly 120.

It may be desirable to minimize secondary reflections from other surfaces of electro-optic element 121 (e.g., surfaces 122A, 122B, 126A where transflective coating 142 is not present) to avoid blurry images (i.e., double imaging). Accordingly, use of antireflective coatings 146 may be advantageous, as described in U.S. Patent Application Publication No. 2016/0370586, entitled “Heads up display system,” and U.S. Patent Application Publication No. 2018/0017834, entitled “Electro-optic element with high double image ratio,” the contents of which are hereby incorporated by reference in their entirety. An example of the antireflective coating 146 may be a transparent conductive oxide.

In some embodiments, a scratch-resistant coating 154 may be disposed on an exterior surface of display element 112 to protect it from scratches and other damage.

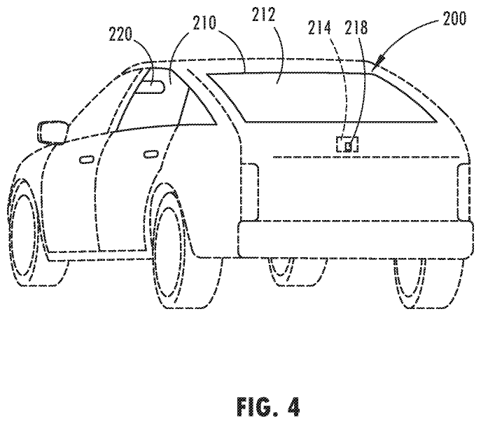

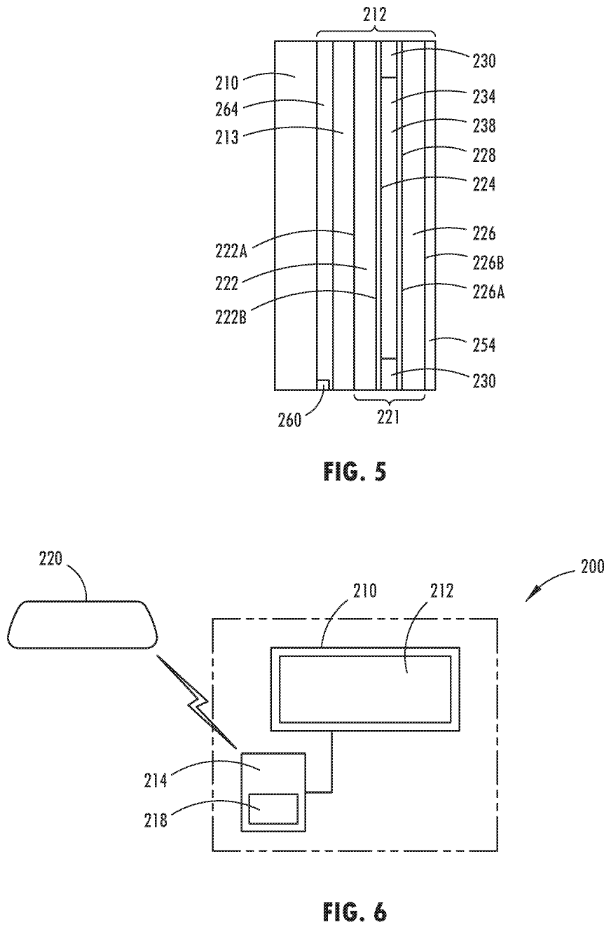

Referring to FIGS. 4-6, an alternative embodiment of window display system is shown generally at 200. Window display system 200 may comprise a window 210 having a display element 212, and an image source 214. Window 210 may be a vehicle window, and may be at least one of a rearview window and a side window. Window 210 may be of tempered glass or may be of laminated glass. Display element 212 may be disposed on a surface of window 210, on either an interior surface or an exterior surface. Display element 212 may comprise an electro-optic element 213. Electro-optic element 213 may comprise a thin, transparent film. In some embodiments, display element 212 may further comprise a light source 260. Light source 260 may be a transparent backlight. Display element 212 may further include a transparent light guide plate 264. Light guide plate 264 may be configured to reflect light from light source 260, moving it to provide light to electro-optic element 213 as a surface light source.

Image source 214 may be in electrical communication with display element 212. Image source 214 may be disposed in proximity to display element 212, or elsewhere within or on the vehicle, such as on a rear shelf, behind a door panel, or any other suitable location.

Image source 214 may comprise a controller 218. Controller 218 may be in electrical communication with a full display mirror assembly 220. Controller 218 may be configured to receive inputs from full display mirror assembly 220 and may be operable to cause images to be displayed on display element 212 upon the receipt of an a first particular input. Display element 212 may be selectively transparent, and may remain in a transparent state with no images generated or displayed on it until it receives a first particular input from controller 218 instructing it to generate and/or display images. Upon the receipt by controller 218 of a first particular input, such as, for example, an input indicating that full display mirror assembly 220 is operating in the display mode, controller may cause images to be displayed upon display element 212. Upon the receipt of a second particular input, such as an input indicating that full display mirror assembly 220 is operating in a mirror mode, controller may cause the display of images on display element 212 to cease and window 210 may return to a high transmission state. A power source (not shown) may be disposed to provide power to window display system 200.

In some embodiments, image source 214 may store image data for at least one image. The at least one image may be a still image or a video image. The at least one image may be displayed on display element 212 upon the receipt of an input that causes images to be displayed on display element 212. Upon activation of window display system 200, image source may access the image data for the at least one stored image and may select and cause the display of an image on display element 214.

In some embodiments, image source 214 may comprise or be in communication with one of a mobile telephone, a tablet computer, and a portable computer. The mobile telephone, tablet computer, or portable computer may include a program or application. The program or application may have or have access to stored image data for the at least one image. The image data for the at least one image may be stored on a local program, or image source 214 may be connected to the internet, and able to access the image data for the at least one stored image through the internet. Image source 214 may have GPS capabilities or may be in communication with a GPS-enabled device, and may select images to be displayed on display element 212 based on the location of the vehicle. Additionally or alternatively, image source 214 may select images randomly or in a predetermined order or rotation.

In some embodiments, image source 214 may further comprise a user interface (not shown). A user may select an image or images to display through the user interface. In some embodiments, user may use the user interface to activate or deactivate window display system 200 or cause images to be displayed or not be displayed on display element 212.

In some embodiments, display element 212 may further comprise an electro-optic layer 221 to prevent light transmission through window 210 when display element 212 is activated. Darkening of electro-optic layer 221 may enhance the visibility of the displayed images. Electro-optic layer 221 may comprise a first substrate 222 having a first surface 222A and a second surface 222B, and a second substrate 226 having a third surface 226A and a fourth surface 226B. One or more layers of electrically conductive material 224 may be associated with second surface 222B of first substrate 222. These layers may serve as an electrode for first substrate 222 of electro-optic layer 221. One or more layers of electrically conductive material 228 may be associated with third surface 226A of second substrate 226, serving as an electrode for second substrate 226. First and second substrates 222, 226 may be positioned in a parallel spaced-apart relationship. A sealing member 230 may extend substantially around a perimeter of first and second substrates 222, 226, operatively bonding the one or more layers of electrically conductive material 224, 228 to second surface 222B of first substrate 222 and third surface 226A of second substrate 226, and defining a cavity 234 therebetween. An electro-optic medium 238 may be disposed in cavity 234 between first and second substrates 222, 226. A power source (not shown) may serve to provide power to electrodes 224, 228, thereby allowing activation of electro-optic layer 221.

In some embodiments, a scratch resistant coating 254 may be disposed on an exterior surface 226B of display element 212 to protect it from scratches or other damage.

The above description is considered that of the preferred embodiments only. Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

In this document, relational terms, such as first and second, top and bottom, front and back, and the like, are used solely to distinguish one entity or action from another entity or action, without necessarily requiring or implying any actual such relationship, order, or number of such entities or actions. These terms are not meant to limit the element which they describe, as the various elements may be oriented differently in various applications.

1. A window display system for a vehicle comprising:
a window having a display element;
a full display mirror assembly;
a controller in communication with the full display mirror assembly;
a display device capable of causing images to be displayed on the display element and in communication with the controller; and
an image source in communication with the display device;
wherein the full display mirror assembly is configured to provide inputs to the controller; and
wherein the window display system is configured to cause images to be displayed on the display element upon receiving a first particular input from the full display mirror assembly.

2. The window display system of claim 1, wherein the image source comprises a controller.

3. The window display system of claim 1, wherein the window is a vehicle window and is one of a rear and a side vehicle window.

4. The window display system of claim 1, wherein the full display mirror assembly has a mirror mode and a display mode; and
wherein the first particular input comprises an input indicating that the full display mirror assembly is in the display mode.

5. The window display system of claim 3, wherein the image source is configured to stop images from being displayed on the display assembly upon receiving a second particular input from the full display mirror assembly; and
wherein the second particular input indicates that the full display mirror assembly is in the mirror mode.

6. The window display system of claim 1, wherein the image source comprises one of a mobile telephone, a tablet computer, and a portable computer.

7. The window display system of claim 6, wherein the image source is linked to a global positioning system; and
wherein the image source is configured to select at least one image to be displayed based on the location of the vehicle.

8. The window display system of claim 7, wherein the at least one image is chosen from a plurality of stored images.

9. The window display system of claim 1, further comprising a shroud; wherein the shroud is disposed to at least partially cover the display device.

10. The window display system of claim 1, wherein the display element comprises a layer that is at least partially reflective and at least partially transmissive.

11. The window display system of claim 1, wherein the display element comprises a first partially reflective, partially transmissive substrate defining a first surface and a second surface;
a second partially reflective, partially transmissive substrate defining a third surface and a fourth surface, wherein the first substrate and the second substrate are configured to be held in a parallel spaced apart relationship and sealed around a perimeter of the first and second substrates;
a transflective coating positioned on at least one of the first and second surfaces of the first substrate;
an antireflective electrode positioned on at least one of the third and fourth surfaces; and
an electro-optic medium positioned in a cavity between the second surface of the first substrate and the third surface of the second substrate;
wherein the electro-optic assembly is configured to reflect an image displayed from a display device, thereby displaying the image on the window display system of the vehicle.

12. A window display system comprising:
a window having a display element; and
an image source comprising a processor;
wherein the image source is configured to cause selected images to be displayed on the display element upon receipt by the window display system of a first particular input from a full display mirror, the full display mirror being in communication with the image source.

13. The window display system of claim 11, wherein the display element comprises a liquid crystal display.

14. The window display system of claim 11, wherein the window is a vehicle window and is one of a rear window and a side vehicle window.

15. The window display system of claim 11, wherein the window display system is configured to suspend the displaying of images on the display element upon receiving a second particular input from the full display mirror assembly.

16. A display system comprising:
a window having a display element;
an image source comprising a processor;
a full display mirror assembly in communication with the processor;
wherein the full display mirror assembly is configured to provide inputs to the processor; and
wherein the processor is configured to provide image data for images to be displayed on display element upon receipt of a first particular input from the full display mirror assembly.

17. The display system of claim 16, wherein the window is a vehicle window.

18. The display system of claim 16, wherein the first particular input indicates that the full display mirror assembly is operating in a display mode.

19. The display system of claim 16, wherein the processor is configured to cause the display element to stop displaying images upon the receipt of a second particular input from the full display mirror assembly; and
wherein the second particular input indicates that the full display mirror assembly is in a mirror mode.

20. The display system of claim 16, wherein the display element is at least partially transmissive and at least partially reflective.
